(19) United States
(12) Patent Application Publication
(10) Pub. No.: US 2007/0057589 A1
(43) Pub. Date: Mar. 15, 2007

(54) Interior permanent magnet rotor and interior permanent magnet motor

(75) Inventors: Kazutaka Tatematsu, Nagoya-shi (JP); Ryoji Mizutani, Nishikamo-gun (JP); Yasuhiro Endo, Okazaki-shi (JP)

Correspondence Address: OLIFF & BERRIDGE, PLC, P.O. BOX 19928, ALEXANDRIA, VA, 22320, US

(73) Assignee: TOYOTA JIDOSHA KABUSHIKI KAISHA, Toyota-shi (JP)

(21) Appl. No.: 11/517,283

(22) Filed: Sep. 8, 2006

(30) Foreign Application Priority Data
Sep. 9, 2005 (JP) JP2005-261514

(51) Int. Cl. H02K 15/12; H02K 1/27

(52) U.S. Cl. 310/156.53; 310/45

(57) ABSTRACT

An interior permanent magnet rotor which reduces rotor loss when used in combination with a concentrated winding stator is provided. A rotor 20 is an interior permanent magnet rotor formed with permanent magnets 23a and 23b embedded inside a rotor core 22. In the rotor 20, in the rotor core 22, a portion between the permanent magnets 23a and 23b and a rotor outer periphery is constructed by a material having far superior high frequency characteristics than the other portions.

### CROSS-REFERENCE TO RELATED APPLICATION(S)

This application claims priority to Japanese Patent Application No. 2005-261514, filed on Sep. 9, 2005, which is incorporated herein by reference in its entirety.

### BACKGROUND OF THE INVENTION

1. Field of the Invention

The present invention generally relates to an interior permanent magnet rotor formed with a permanent magnet embedded inside a rotor core, and a permanent magnet embedded motor using this.

2. Description of the Related Art

A motor (hereinafter, called a concentrated winding IPM motor) which is constructed by combining a concentrated winding stator made by concentratedly winding a coil on teeth of a stator core, and an interior permanent magnet (IPM: Interior Permanent Magnet) rotor formed with a permanent magnet embedded inside a rotor core is known. Reference should be made, for example, to Patent Document 1 (Japanese Patent Laid-Open Publication No. 2003-88019).

FIG. 2 is a schematic sectional view of the concentrated winding IPM motor disclosed in Patent Document 1. In FIG. 2, the concentrated winding IPM motor is a three-phase, four-pole motor, and is constructed by a concentrated winding stator 50 and an interior permanent magnet rotor 60 which is disposed inside the stator 50. The stator 50 is made by concentratedly winding coils 52u, 52v and 52w respectively of U, V and W phases on six teeth 51a, 51b, 51c, 51d, 51e and 51f provided at a stator core 51. Meanwhile, the rotor 60 is made by embedding permanent magnets 63a, 63b and 63c corresponding to four magnetic poles inside a rotor core 62 fitted to a rotary shaft 61. Since in this construction the permanent magnets are embedded in the rotor core, reluctance torque can be utilized in addition to magnetic torque, and high efficiency can be obtained. Since the coil of the stator is concentratedly wound, reduction in size and reduction in cost can be achieved compared with distributed winding.

As documents in the field related to the present invention, Japanese Patent Laid-Open Publication No. 2000-166135, Japanese Patent Laid-Open Publication No. 2001-286109, Japanese Patent Laid-Open Publication No. 2001-238382, Japanese Patent Laid-Open Publication No. 2001-332411 and the like are cited.

In FIG. 2, paying attention to the magnetic pole (N pole) at the upper left side, the tooth in which the magnetic flux coming out of the magnetic pole flows is switched in such a manner that it is switched from the teeth 51a to 51b to 51c to 51d etc. At this time, in the concentrated winding type, the teeth pitches are large, and therefore the magnetic flux is bent sharply, thus causing a large eddy current based on this change in magnetic flux. More specifically, when a certain magnetic pole passes the teeth corresponding to three phases, the magnetic flux changes abruptly three times. Therefore, a harmonic wave three times as high as the stator fundamental frequency (frequency of three-phase AC supplied to the stator) occurs, and rotor loss (eddy current loss) increases. Here, most of the regions where the harmonic wave occurs are in a portion where the magnetic flux changed abruptly, namely, a portion 62a between the permanent magnets 63a, 63b and 63c and the rotor outer periphery, of the rotor core 62. In this way, in the concentrated winding IPM motor, rotor loss generally increases when the fundamental frequency is made high.

### SUMMARY OF THE INVENTION

An interior permanent magnet rotor according to the present invention is an interior permanent magnet rotor formed with a permanent magnet embedded inside a rotor core, and in the above described rotor core, a portion between the above described permanent magnet and a rotor outer periphery is constructed by a material having far superior high frequency characteristics than the other portions.

Further, in one embodiment, the interior permanent magnet rotor according to the present invention is an interior permanent magnet rotor formed with permanent magnets embedded inside a stacked core made by stacking a plurality of electromagnetic steel sheets, and it is preferable that in the above described stacked core, in portions between the above described permanent magnets and a rotor outer periphery, insertion holes are formed along a rotor rotary shaft direction, and dust cores formed by pressure-molding magnetic powder coated with an insulating film are inserted in the above described insertion holes.

The interior permanent magnet motor according to the present invention is constructed by combining the above described interior permanent magnet rotor and a concentrated winding stator.

According to the present invention, rotor loss is reduced.

### BRIEF DESCRIPTION OF THE DRAWINGS

FIG. 1 is a schematic sectional view of a concentrated winding IPM motor according to an embodiment; and

FIG. 2 is a schematic sectional view of a concentrated winding IPM motor disclosed in Patent Document 1.

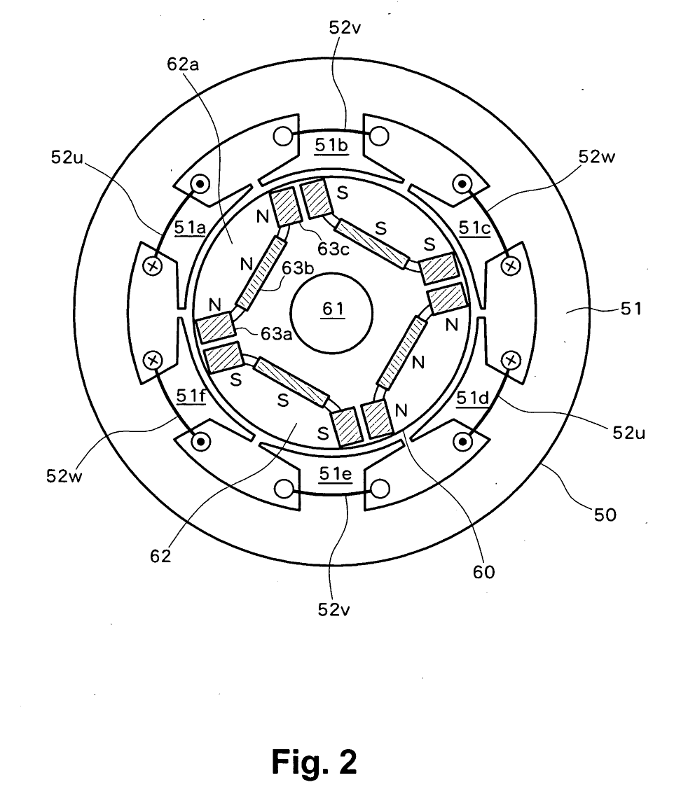

### DESCRIPTION OF THE PREFERRED EMBODIMENTS

An embodiment of the present invention will now be described in accordance with the drawings.

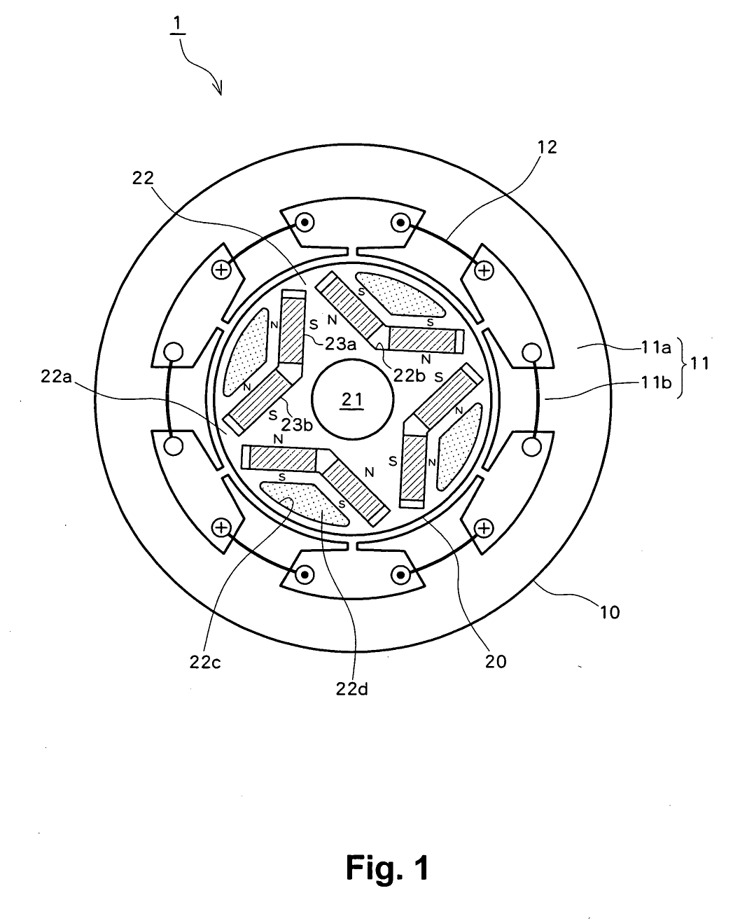

FIG. 1 is a schematic sectional view of a concentrated winding interior permanent magnet (IPM) motor 1 according to the present embodiment. The concentrated winding IPM motor 1 is a motor constructed by combining a concentrated winding stator 10 and an interior permanent magnet rotor 20.

The stator 10 is in a substantially cylindrical shape, and is constructed mainly by a stator core 11 and a coil 12 which is wound around the stator core 11. The stator core 11 is constructed by a substantially cylindrical yoke part 11a, and 3n (n is a positive number, n=2 in FIG. 1) of tooth portions 11b provided at predetermined intervals inside the yoke part 11a to extend toward a center axis. The stator core 11 is preferably formed by stacking a plurality of thin electromagnetic steel sheets (silicon steel sheets or the like) in an axial direction. The coil 12 of each phase is wound on 3n tooth portions 11b by concentrated winding.

The rotor 20 is in a substantially cylindrical shape, and is disposed inside the stator 10 via an air gap coaxially with the stator 10. The rotor 20 includes a rotary shaft 21. A cylindrical rotor core 22 with the rotary shaft 21 as a center shaft is fitted to the rotary shaft 21. Permanent magnets corresponding to 2n poles (four poles in FIG. 1) are embedded inside the rotor core 22. In the rotor core 22, a portion between the permanent magnet and the rotor outer periphery is constructed by a material (material with small iron loss in a high frequency region) having far superior high frequency characteristics than the other portions in view of reducing the high frequency iron loss in that portion.

More specifically, in this embodiment, most of the rotor core 22 is constructed by a stacked core 22a which is made by stacking a plurality of electromagnetic steel sheets (silicon steel sheets or the like) in the axial direction. In the stacked core 22a, the same number of V-shaped permanent magnet insertion holes 22b which are projected toward the center of the rotor as the number of magnetic poles (four in this case) are equidistantly formed in the circumferential direction. With each of the permanent magnets being disposed on two sides constructing a V-shape, a pair of permanent magnets 23a and 23b each in a rectangular parallel piped shape extending in the axial direction are inserted in each of the permanent magnet insertion holes 22b. A pair of permanent magnets 23a and 23b are magnetized so that polarities at the side of the rotor outer periphery become the same, thus constituting one magnetic pole. Accordingly, four magnetic poles are constructed by four pairs of permanent magnets 23a and 23b. A pair of permanent magnets 23a and 23b of each pair are magnetized so that the adjacent poles differ in polarity. Accordingly, N poles and S poles are alternately disposed along the rotor circumferential direction.

Further, in the portions between the permanent magnet insertion holes 22b and the rotor outer periphery of the stacked core 22a, a total of four dust core insertion holes 22c are formed along the direction of the rotary shaft 21. Dust cores 22d are inserted into the respective dust core insertion holes 22c. The dust core 22d, as is widely known, is made by pressure-molding magnetic powder coated with an insulating film, having small iron loss in the high frequency region, and excellent high frequency characteristics. The size of the dust core insertion hole 22c is suitably set based on the strength and high frequency characteristic required for the rotor 20.

In the above described construction, when a three-phase AC is supplied to the coil 12 of the stator 10, a rotating field occurs, and the rotor 20 rotates around the rotary shaft 21 due to magnet torque and reluctance torque. At this time, as described above, abrupt change in magnetic flux occurs in the areas between the permanent magnets and the rotor outer periphery, of the rotor core 22, and the harmonic wave three times as high as the stator fundamental frequency (frequency of the above described three-phase AC) occurs. Since in this embodiment the dust cores 22d having excellent high frequency characteristics are disposed in the areas where the harmonic wave occurs, the eddy current due to the harmonic wave is suppressed, and rotor loss can be kept low.

As described above, in the IPM rotor according to this embodiment, the portions between the permanent magnets and the rotor outer periphery, of the rotor core, are constructed by a material having far superior high frequency characteristics than the other portions. Therefore, according to the IPM rotor according to this embodiment, when the concentrated winding stator and the IPM rotor are used in combination, the rotor loss due to the harmonic wave occurring to the portion between the permanent magnet and the rotor outer periphery can be reduced. As a result, it becomes possible to make the stator fundamental frequency higher, and it becomes possible to use the concentrated winding IPM motor at a high rotational frequency. As a result, it becomes possible to provide a concentrated winding IPM motor suitable for a vehicle traveling motor for which a high frequency is required.

In the IPM rotor according to the present embodiment, the portion where the harmonic wave occurs is constructed by a material having far superior high frequency characteristics than the other portions, and therefore the problem which occurs when the entire rotor core is constructed by a material having excellent high frequency characteristics can be avoided. For example, when the entire rotor core is constructed by stacking very thin electromagnetic steel sheets, rotor loss is reduced, but press formability is decreased and cost becomes high. For example, when the entire rotor core is constructed by the dust core, rotor loss reduces but strength reduces, and the rotor cannot be rotated at high rotation.

In the IPM rotor according to the present embodiment, most of the rotor core is the stacked core formed by stacking a plurality of electromagnetic steel sheets. The dust core insertion holes are formed in the portions between the permanent magnets and the rotor outer periphery, of the stacked core, and the dust cores are inserted into the dust core insertion holes. Therefore, according to the IPM rotor according to the present embodiment, high frequency characteristic can be increased while high strength is maintained. The IPM rotor can be manufactured with a relatively easy method, and the cost can be reduced.

The present invention is not limited to the above described embodiment, and various changes can be made therein without departing from the spirit of the present invention. For example, the present invention is widely applicable to the concentrated winding IPM motor in which the concentrated winding stator and the IPM rotor are combined, and the concrete construction of the stator (the number of teeth, shape, material and the like), and the concrete construction of the rotor (the number of poles, disposition pattern of the permanent magnets, shape, material and the like) are appropriately changeable. In the above described embodiment, the dust core is used as the material having excellent high frequency characteristics, but the material is not especially limited to this.

What is claimed is:

1. A rotor used in a motor, comprising:
a rotor core; and
a plurality of permanent magnets embedded inside the rotor core,
wherein in said rotor core, portions between said permanent magnets and an outer periphery of the rotor core are constructed by a material having far superior high frequency characteristics than the other portions.

2. The rotor according to claim 1, wherein said rotor core is cylindrical, said plurality of permanent magnets are provided equidistantly along a circumferential direction, and are respectively disposed in a plurality of magnet insertion openings extending in a direction parallel with a rotary shaft of the rotor.

3. The rotor according to claim 2, wherein a plurality of material insertion openings are provided between said plurality of magnet insertion openings of said rotor core and the outer periphery of said rotor core, and the material having superior high frequency characteristics is placed in the material insertion openings.

4. The rotor according to claim 3, wherein said material having superior high frequency characteristics is a dust core formed by pressure-molding magnetic powder coated with an insulating film.

5. The rotor according to claim 4, wherein a shape of each of said plurality of magnet insertion openings seen from an end surface side of the rotor core is a V shape with a central portion facing a center of the rotor core, and a shape of said material insertion opening seen from the end surface side of the rotor core is in a triangular shape corresponding to the shape of the magnet insertion opening.

6. The rotor according to claim 5, wherein two permanent magnets separated at a central portion are inserted in each of said plurality of magnet insertion ports.

7. The rotor according to claim 1, wherein said rotor core is formed by stacking a plurality of disk-shaped electromagnetic steel sheets.

8. A motor, wherein said motor is constructed by combining the rotor set forth in claim 1 and a concentrated winding stator.
